(19) United States
(12) Patent Application Publication
(10) Pub. No.: US 2009/0194378 A1
(43) Pub. Date: Aug. 6, 2009

(54) BRAKE SHIELD

(75) Inventor: Stefan SAND, Hjartum (SE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/359,200

(22) Filed: Jan. 23, 2009

(30) Foreign Application Priority Data
Jan. 24, 2008 (EP) 08001273.5-1523

(51) Int. Cl. F16D 55/00

(52) U.S. Cl. 188/73.47

(57) ABSTRACT

A brake shield is provided to cover a brake disc in a vehicle. The brake shield is arranged to at least partly cover one side of the brake disc, and the brake shield includes, but is not limited to a cover portion adapted to cover a hub of said brake disc.

### CROSS-REFERENCE TO RELATED APPLICATION

This application claims priority to European Patent Application No. 08001273.5-1523, filed Jan. 24, 2008, which is incorporated herein by reference in its entirety.

### TECHNICAL FIELD

The present invention relates to a brake shield to cover a brake disc in a vehicle.

### BACKGROUND

Brake shields for use in disc brake arrangements are well known in the art and used for shielding the part of a brake disc inner side that is not covered by the brake caliper. To stop the wheel, friction material in the form of brake pads, mounted in the brake caliper, is forced mechanically, hydraulically, pneumatically or electromagnetically against both sides of the brake disc. Friction causes the brake disc and the attached wheel to slow or stop.

Adjacent the brake disc, at the centre part of a disc brake arrangement, a vehicle wheel speed sensor may be arranged. Vehicle wheel speed sensors are well known in the art and are used for measuring the rate of rotation of a vehicle wheel. Information from vehicle wheel speed sensors are critical to many important systems in the vehicle such as the vehicle anti-lock braking systems (ABS), traction control systems (TCS), electronic stability program (ESP), electronically controlled suspension system and a power steering system. Such systems rely on accurate speed signals. Each wheel on a vehicle usually has its own speed sensor, which sends a signal to a control module.

During vehicle operation, a transmitter mounted on the rotating vehicle wheel sends a signal to the wheel speed sensor indicating the rotational speed of the associated vehicle wheel, and the wheel speed sensor transmits a signal to a control module, corresponding to the rotational speed of the vehicle wheel. The speed sensor is commonly an electromagnetic sensor that reacts to a corresponding electrical signal. Wheel speed sensors for automobiles typically utilize an encoder ring mounted at a wheel and a receiver that detects the passage of a marker element as the wheel turns. The output signal could be either a measure of the speed or changes in the speed.

The position of the wheel speed sensor in a vehicle exposes it to dirt, water, ice and other foreign objects that could cause damage to the sensor and lead to measuring faults. In particular, iron particles that detaches from the brake disc can cause measuring faults in an electromagnetic sensor. Hence, it is important to protect the vehicle wheel speed sensor from these kinds of contaminations.

The conventional way of protecting a vehicle wheel speed sensor is to have a sensor cover placed over the sensor. This also protects the sensor from particles detached from the wheel and tire when braking. Due to the assembling of the surrounding parts, such a sensor cover is mounted over work-pieces as the adapter plate and the carrier for the disc brake and hub components. However, it is becoming increasingly common, due to flexibility demands, to assemble the vehicle wheel speed sensor at a later stage instead of having it factory-assembled, which implies subsequent assembling of the sensor cover.

In addition, there is always a need to improve the manufacturing and assembling process within the vehicle industry. Furthermore, an objective of the present invention is to solve or at least reduce the problems discussed above. In particular, an objective is to provide an improved brake shield with additional shielding features. Moreover, other needs, objectives, desirable features and characteristics will become apparent from the subsequent summary and detailed description, and the appended claims, taken in conjunction with the accompanying drawings and this background.

### SUMMARY

According to a first aspect, the inventive concept relates to a brake shield to cover a brake disc in a vehicle, and the brake shield is arranged to cover one side of the brake disc at least partly, and the brake shield comprises a cover portion adapted to cover a hub of the brake disc. At least one advantage of the inventive concept concerns the assembling of the brake shield. Since the brake shield comprises a cover portion, assembling of a separate work-piece for covering the hub of the brake shield becomes unnecessary. In addition, having a brake shield that comprises such a cover portion allows benefiting from synergy effects, since the brake shield may be suitable for different vehicles and, again, no separate work-piece, specific for each vehicle model, for covering the hub of the brake shield is necessary. This also saves tool costs.

Preferably, the cover portion covers at least partly a wheel speed sensor. The cover portion of the brake shield covers a wheel speed sensor and hence no separate wheel speed sensor cover is needed. This saves process steps in both assembling and manufacturing of a separate speed sensor cover.

Advantageously, the brake shield and the cover portion are made in one part. Having the brake shield in one part assures a tight sealing between the cover portion and the rest of the brake shield without the need of any sealing joint or packing. In addition, process steps are saved in manufacturing since no separate work-piece for covering the hub of the brake disc is needed. Alternatively, the brake shield and the cover portion are made in separate parts which may be beneficial for instance if different materials are used for the different parts of the brake shield. Suitably, the cover portion protrudes from the main part of the brake shield. Such a design allows for fitting a wheel speed sensor inside the protruding cover portion.

Preferably, the brake shield comprises at least one opening suitable for inserting a wheel speed sensor. The opening allows for fastening the wheel speed sensor outside of the brake shield and having the wheel speed sensor inserted through the opening. Such an opening also facilitates installation of the wheel speed sensor at a later stage if the wheel speed sensor is not factory-assembled.

Alternatively, the cover portion is adapted to be a retainer for a wheel speed sensor. This design could be advantageously since the cover portion of the brake shield holds the wheel speed sensor in position and hence no additional fastening means is necessary.

Yet another way of holding the wheel speed sensor in place and save additional fastening means could be to have some other part of the brake shield adapted to be a retainer for a wheel speed sensor.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

A preferred embodiment will hereinafter be described in conjunction with the following drawing FIGURE, and

FIG. 1 is a perspective view showing a brake shield with a protracted brake disc.

### DETAILED DESCRIPTION

The following detailed description is merely exemplary in nature and is not intended to limit application and uses. Furthermore, there is no intention to be bound by any theory presented in the preceding background or summary or the following detailed description. In addition, the above, as well as additional objects, features and advantages of the present invention, will be better understood through the following illustrative and non-limiting detailed description of preferred embodiments, with reference to the appended drawing, where the same reference numerals will be used for similar elements.

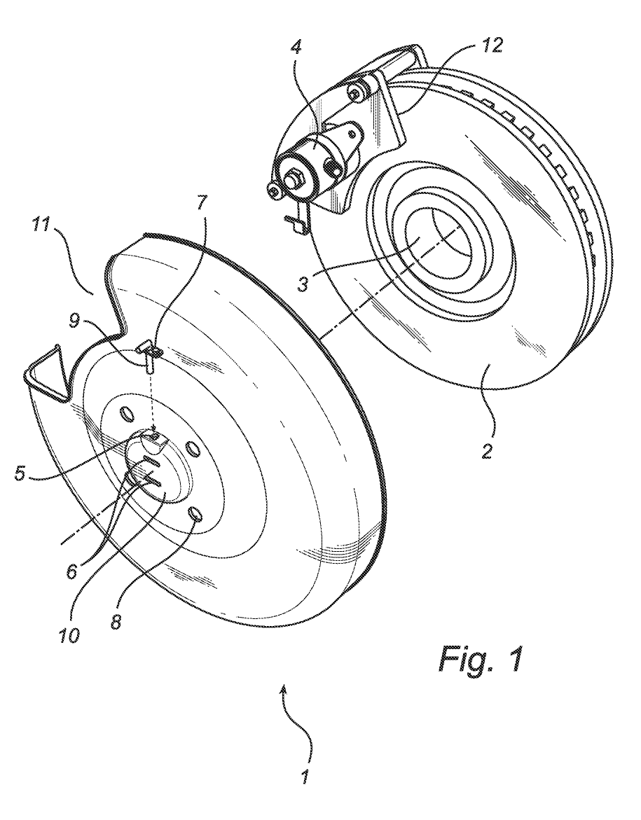

In FIG. 1, a brake shield 1 according to one embodiment of the present invention is shown. The brake shield 1 is arranged to cover one side of a brake disc 2 at least partly. The brake shield 1 comprises a cover portion 10 adapted to cover a hub 3 of the brake disc 2. To visualize the arrangement clearly, the brake disc 2 with the hub 3 and the brake caliper 4 with brake pads 12 are shown protracted from the brake shield 1. When arranged to a vehicle, the brake shield is arranged adjacent the brake disc at the inner side of the brake disc, as seen from the vehicle. The brake shield 1 has a recess 11 to fit the brake caliper 4.

The brake shield 1 in FIG. 1 has a cup-shaped cover portion 10 that covers the hub 3 of the brake disk 2. Moreover, the brake shield 1 covers a wheel speed sensor 9 that is inserted through an opening 5 in the brake shield 1 and suspended in a fixing member 7. The fixing member 7 is, in this particular embodiment, arranged on an adapter plate (not shown) which also holds the brake caliper 4. However, other arrangements are possible. For instance, the brake shield itself could be adapted to be the retainer for the wheel speed sensor 9 so that no additional fixing member is needed. Even though FIG. 1 shown a cup-shaped cover portion, a flat cover portion would also be possible, depending on the design of the wheel speed sensor 9 or other surrounding parts. Further, the brake shield embodiment shown in FIG. 1 has bore holes 8 for mounting of the brake shield and is adapted for a non-driven wheel of a vehicle since it has no driving axle.

Additionally, the embodiments of present invention provide a beneficial solution that facilitates assembling of wheel speed sensor equipments since the brake shield can have the functionality of a wheel speed sensor cover. The wheel speed sensor 9 can be either factory-assembled or equipped at a later stage, the latter being increasingly common due to flexibility demands. If the wheel speed sensor 9 is equipped at a later stage the present invention facilitates the assembling since the brake shield can be made in one part and pre-assembled, and the wheel speed sensor 9 can be inserted into the opening 5 at the cover portion 10 of the brake shield 1.

As can be seen in FIG. 1, the cover portion may have ventilation apertures 6. The ventilation apertures 6 allows the wheel speed sensor 9 accommodation, which might be rather hot due to heat produced from the brakes, to be ventilated by circulation of surrounding air.

In a preferred embodiment of the present invention, the brake shield is a thin walled shell made of for instance a carbon steel material that can be varnished to better withstand corrosion.

Although the embodiments of present invention has been described in connection with particular embodiments thereof, it is to be understood that various modifications, alterations and adaptations may be made by those skilled in the art without departing from the spirit and scope of the invention. Examples of such modifications are different kinds of materials and shapes of and, additional openings or recesses in the brake shield to fit other components. Furthermore, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An apparatus adapted to cover a brake disc of a vehicle, comprising:
a brake shield arranged to at least cover one side of the said brake disc; and
a cover portion of the brake shield adapted to cover a hub of said brake disc.

2. The apparatus according to claim 1, wherein said cover portion at least partly covers a wheel speed sensor.

3. The apparatus according to claim 1, wherein said brake shield and said cover portion are made in one part.

4. The apparatus according to claim 1, wherein said brake shield and said cover portion are made in separate parts.

5. The apparatus according to claim 1, wherein said cover portion protrudes from a main part of said brake shield.

6. The apparatus according to claim 1, wherein said brake shield comprises at least one opening adapted for insertion of a wheel speed sensor.

7. The apparatus according to claim 1, wherein said cover portion is adapted to be a retainer for a wheel speed sensor.

8. The apparatus according to claim 1, wherein said brake shield is adapted to be a retainer for a wheel speed sensor.
